(19) United States
(12) Patent Application Publication
(10) Pub. No.: US 2018/0229380 A1
(43) Pub. Date: Aug. 16, 2018

(54) SAFETY KNIFE

(71) Applicant: Allway Tools, Inc., Bronx, NY (US)

(72) Inventor: Donald Gringer, New York, NY (US)

(73) Assignee: Allway Tools, Inc., Bronx, NY (US)

(21) Appl. No.: 15/434,573

(22) Filed: Feb. 16, 2017

(51) Int. Cl. B26B 3/08

(52) U.S. Cl. CPC B26B 3/08

(57) ABSTRACT

A safety knife for cutting an object that prevents contact with and/or damage to contents housed within a container. The knife includes a head, a cutting blade mounted thereto, a first wing member fixed to and extending from a first side of the blade, a second wing member fixed to and extending from a second side of the blade and at least one nib extending externally from at least one of the wing members or from another portion of the knife.

### FIELD OF THE INVENTION

The present invention relates generally to a knife and more specifically to a knife that includes safety features that can both puncture and cut wrappings of an object.

### BACKGROUND OF THE INVENTION

In general, safety knives can be used to aid in puncturing and/or opening a sealed container. Two known safety knives, for example, are the “Kevlar Kutter” and the “Kevlar Koncept”. These knifes are designed to reduce injuries when cutting an object, such as the wrapping of container, to extend the life of the cutting blade and to reduce damage to objects housed in boxes or packages. However, known safety knives, including those mentioned above, do not provide a means to puncture a sealed container while ensuring the knife does not contact and/or damage the contents housed therein.

### SUMMARY OF THE INVENTION

The present invention relates broadly to a safety knife designed to ensure the cutting and/or puncture features of the knife do not contact contents housed within a box or a package. The knife includes a head, a cutting blade mounted thereto, a first wing member fixed to and extending from a first side of the blade, a second wing member fixed to and extending from a second side of the blade and at least one nib extending externally from at least one of the wing members or from another portion of the knife.

In an embodiment the present invention is directed to a knife for cutting an object that comprises a handle, a head that extends from the handle, a first wing member that is spaced from a first side of the head forming a first slot between the head and the first wing member, a second wing member that is spaced from a second side of the head, mirror opposite the first wing member forming a second slot between the head and the second wing member, a cutting blade that includes at least one nib extending therefrom and is centrally fixed within the head and within the wing members such that the cutting blade spans the first slot and the second slot with the nib extending from the blade, beyond an outer periphery of one of the first wing member and the second wing member, whereby the nib and blade are configured to puncture and cut an object. The outer periphery of the nib can be round at a distal portion thereof.

The knife can include a second nib with the first nib extending from the blade, beyond an outer periphery of the first wing member and the second nib extending beyond the outer periphery of the second wing member. The nib and the blade can each extend along a same plane. The blade and the nib can be comprised of a single piece of material, which can be, for example, metal. At least one of the sidewalls of the blade can have a sharp edge.

In an embodiment the present invention is directed to a knife that includes a handle, a head that extends from a first end of the handle, a first wing member that is spaced from a first side of the head forming a first slot between the head and the first wing member, a second wing member that is spaced from a second side of the head, mirror opposite the first wing member forming a second slot between the head and the second wing member, a cutting blade that is centrally fixed within the head and within the first wing member and the second wing member such that the cutting blade spans the first slot and the second slot and a nib fixed to and extending from a second end of the handle.

The knife can include a single nib. The nib can be substantially rectangular and can have an opening formed therein. The nib can have a first leg extending from the handle, a second leg spaced from and extending substantially parallel to the first leg from the handle and a third leg, spaced from the handle and extending substantially perpendicular between the first leg and the second leg. The nib can have a first rounded corner and a second rounded corner that is spaced from the first rounded corner at a distal end of the nib.

### BRIEF DESCRIPTIONS OF THE DRAWINGS

FIG. 1 is a perspective view of a first embodiment of a safety knife of the present invention;

FIG. 2 is a front view of the safety knife of FIG. 1;

FIG. 3 is a side view of the safety knife of FIG. 1;

FIG. 4 is a top view of the safety knife of FIG. 1;

FIG. 5 is a bottom view of the safety knife of FIG. 1;

FIG. 6 is a cross-sectional view showing a blade with nibs in relation to the housing and cutting wings taken along the line 6-6 of FIG. 4;

FIGS. 7 and 8 show views of an embodiment of a blade that includes nibs;

FIGS. 9-12 show the knife of FIG. 1 puncturing and cutting a sealed container;

FIG. 13 shows a second embodiment of a safety knife with a single nib;

FIG. 14 shows a perspective view of the safety knife of FIG. 13;

FIG. 15 shows a top perspective view of the safety knife of FIG. 13;

FIG. 16 shows a side perspective view of the safety knife of FIG. 13;

FIG. 17 shows a bottom perspective view of the safety knife of FIG. 13; and

FIG. 18 shows a first sectional view of the segment view of the safety knife of FIG. 13; and

FIG. 19 shows a second sectional view of the segment view of the safety knife of FIG. 13.

### DETAILED DESCRIPTION OF EMBODIMENTS OF THE INVENTION

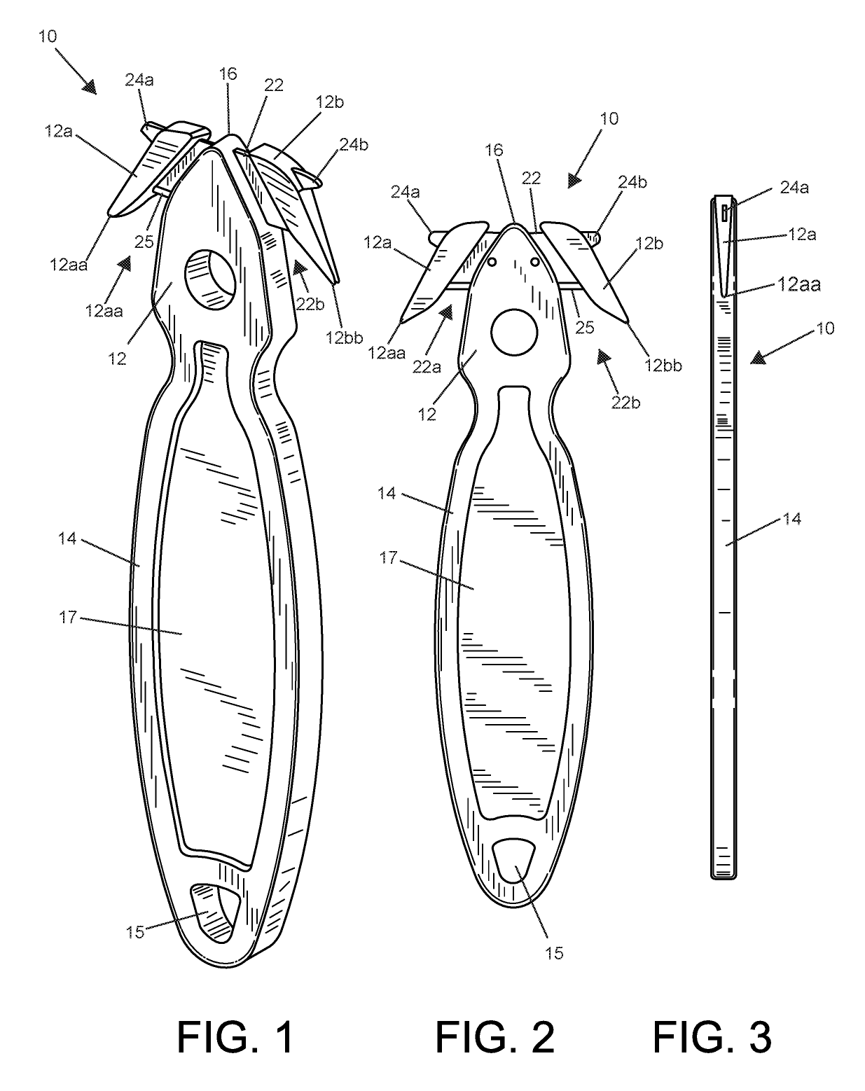

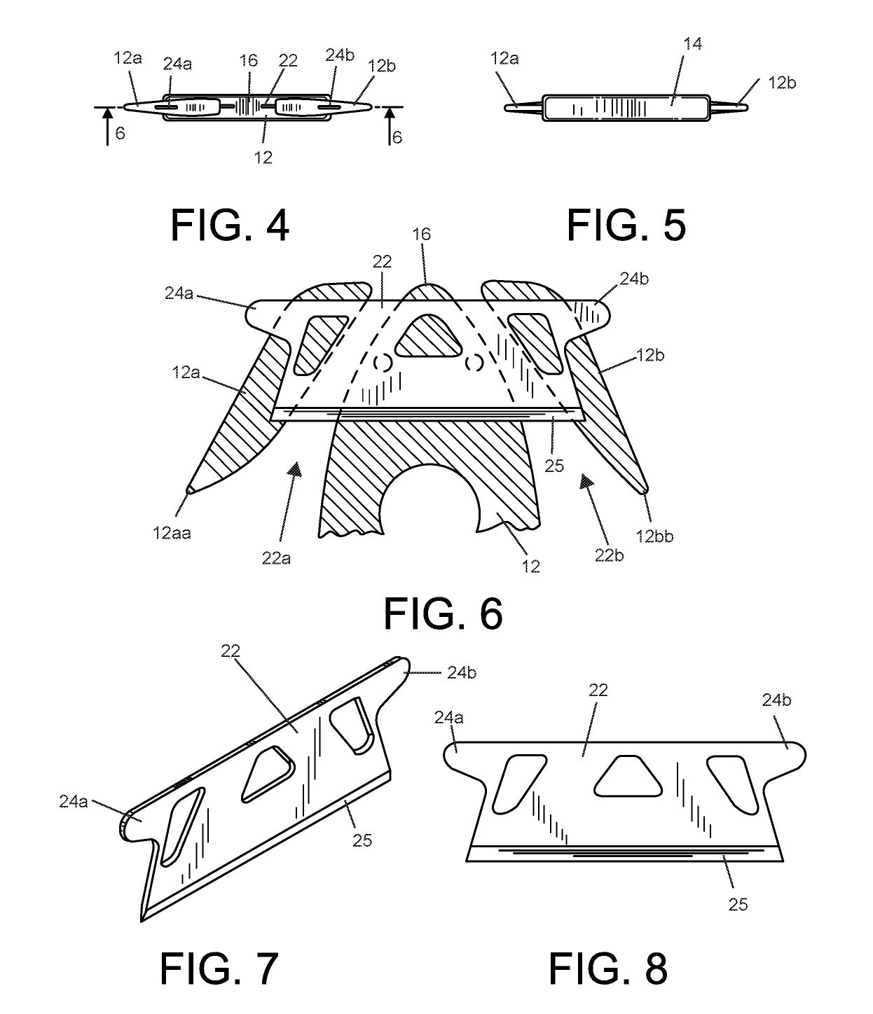

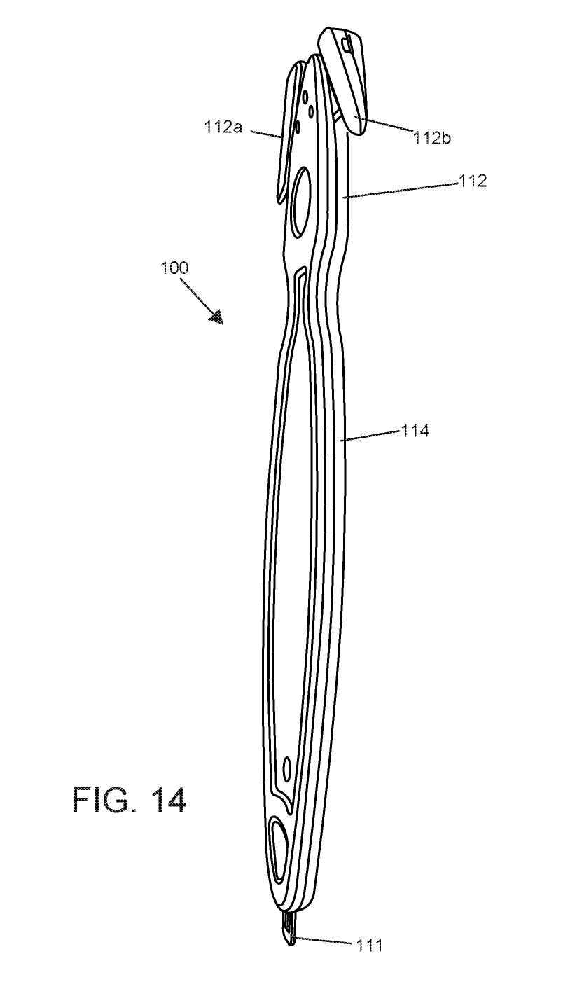

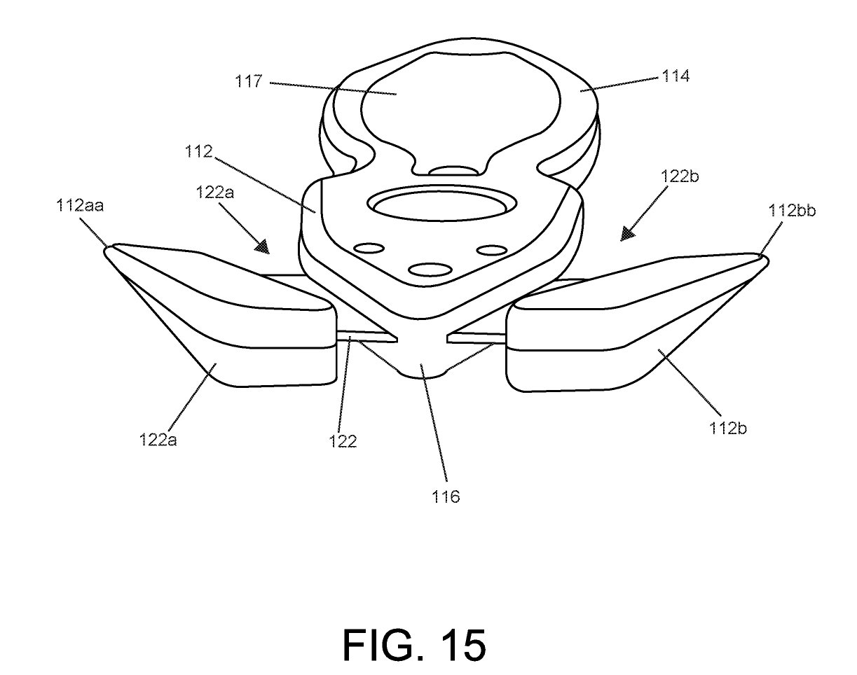

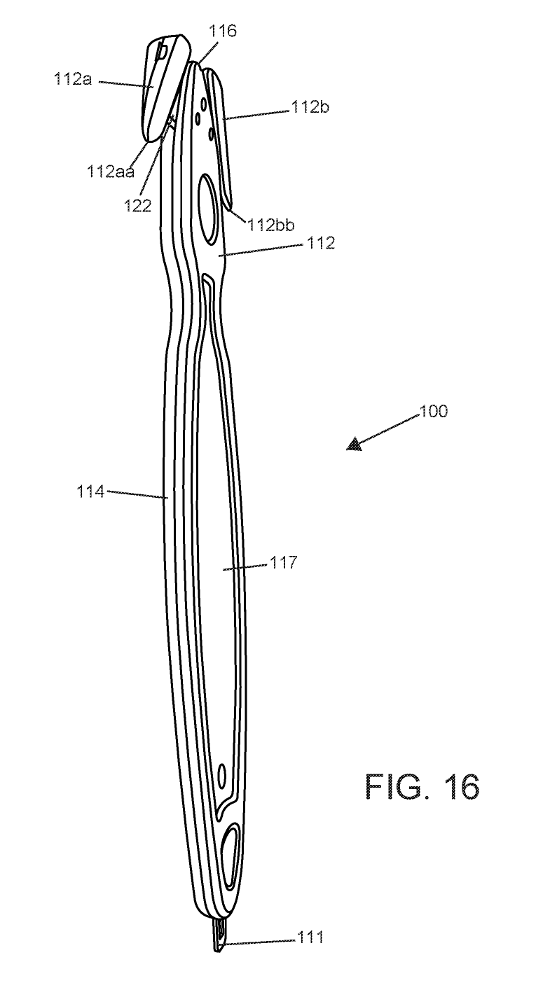

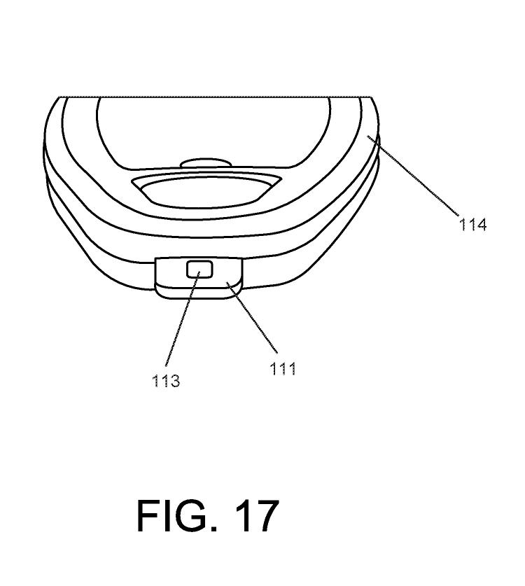

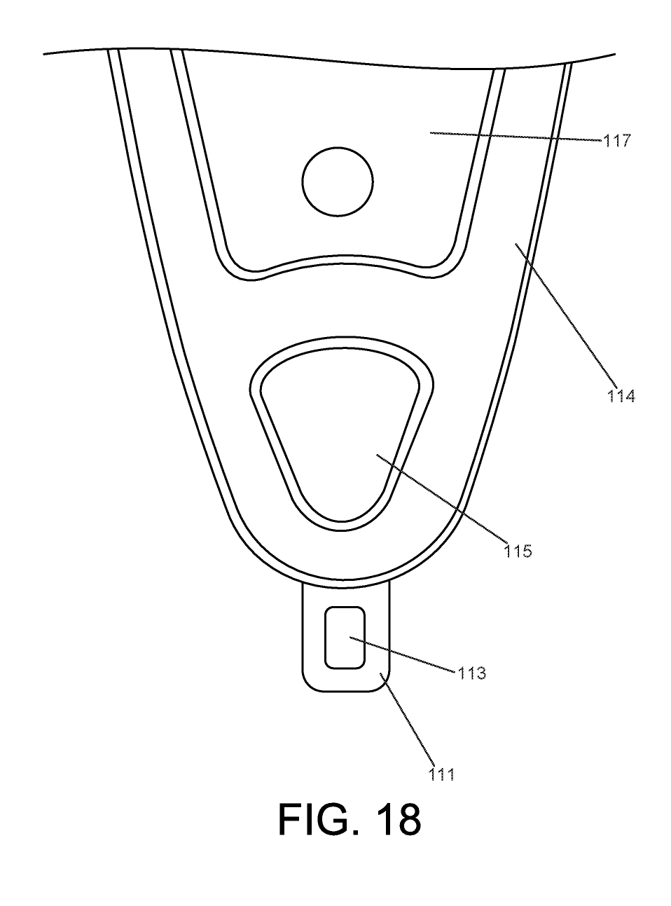

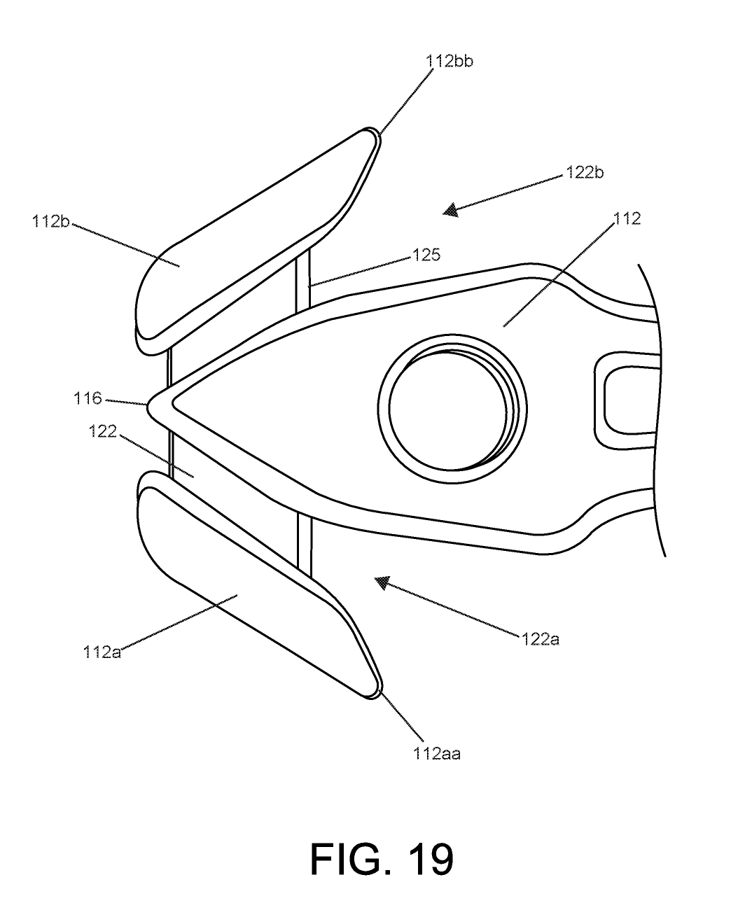

With reference now to the drawings, and in particular to FIGS. 1 through 19, embodiments of a safety knife assembly of the present invention will be described.

FIGS. 1-12 illustrate a first embodiment of a safety knife 10 that generally includes a head 12, a handle 14 and a cutting blade 22. The handle 14 includes central recesses 17 on each side thereof and an opening 15 at a lower portion thereof. The head 12 includes a pair of opposed wings 12a, 12b that are spaced from a first side and a second side of the head 12 such that elongated cutting slots 22a, 22b, respectively, are formed between the wings 12a, 12b and the head 12 with each slot 22a, 22b exposing a portion of the blade 22. The wings 12a, 12b are generally triangular and/or wedged shaped (see e.g., FIGS. 3, 11 and 12), extend away from the apex 16 of the head 12 and converge at a tip 12aa, 12bb, respectively, that is shaped to readily penetrate an object (e.g., cardboard or plastic sheeting).

The wings 12a, 12b are connected to the head 12 by the cutting blade 22 (see FIGS. 3, 6, 7, and 8). In an embodiment, the blade 22 is generally rectangular in shape, has a sharp, elongated edge 25 at a lower portion thereof, a first nib 24a and a second nib 24b. The blade 22 is optionally formed of a stiff metal. The cutting slots 22a, 22b allow for the edge 25 of the blade 22 to contact and cut an object while at the same time preventing a user to contact the edge 25 of the blade 22 with their hand.

As shown in FIGS. 6-8, the first nib 24a extends from a first side of the blade 22 and the second nib 24b extends mirror opposite that of the first nib 24a, from a second side of the blade 22 with each of the nibs 24a, 24b positioned at an upper portion of the blade 22 and integral therewith. The nibs 24a, 24b are each generally rounded at distal ends thereof to prevent injury to a user and can readily penetrate an object (e.g., packaging material such as cardboard or plastic film).

In an assembled state, the blade 22 is centrally fixed within the head 12 and within the body of each wing 12a, 12b. In addition to the cutting slots 22a and 22b formed between the wings 12a, 12b, respectively, the first nib 24a protrudes beyond the first wing 12a and the second nib 24b protrudes beyond the second wing 12b.

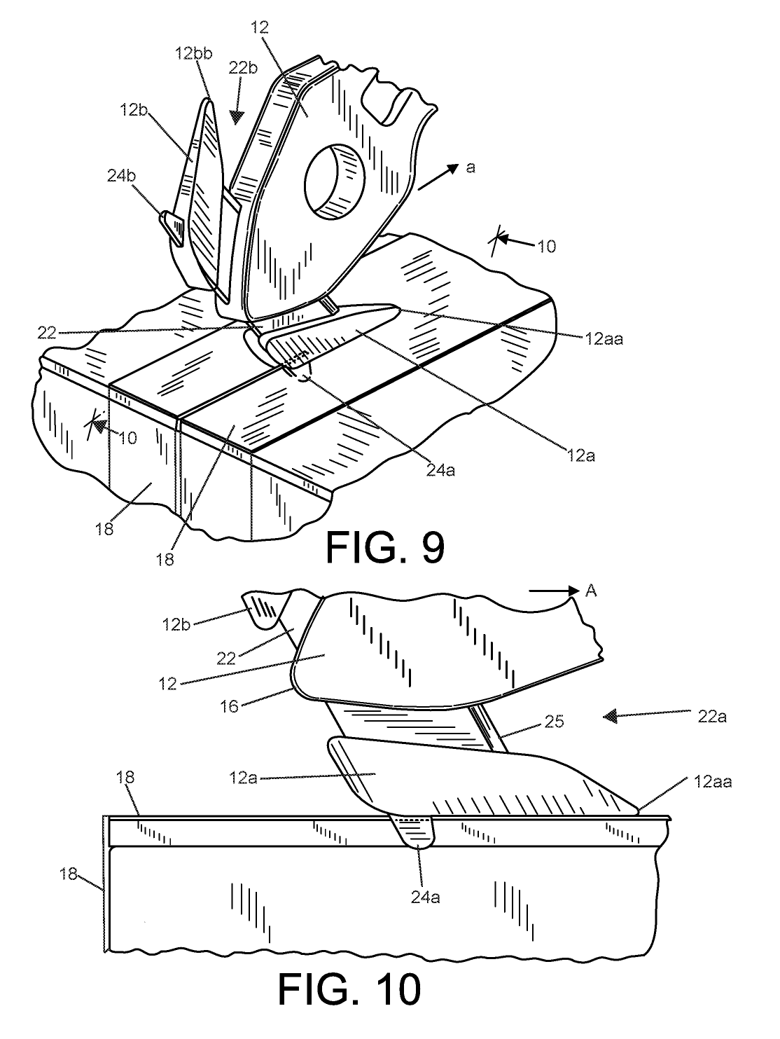

As seen in FIGS. 9 and 10, the nib 24a can penetrate and slice the packaging P in the direction A to aid in opening the packaging P. The wing 12a acts as a stop by contacting, but not penetrating the packaging P with the nib 24a.

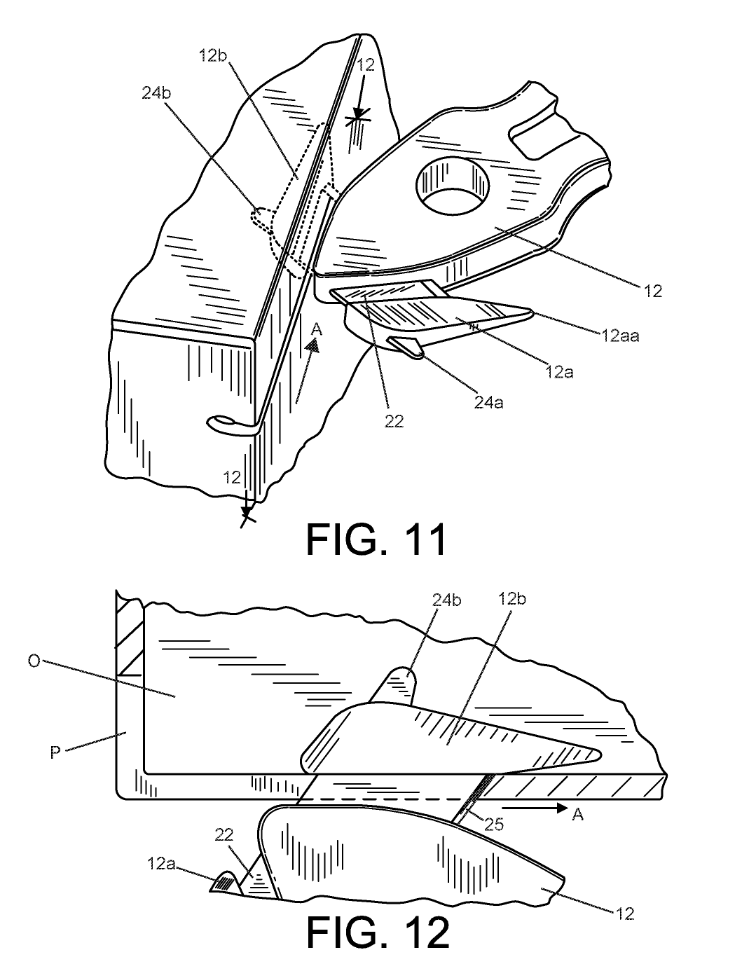

As seen in FIGS. 11 and 12, the tip 12bb of the wing 12b of the knife 10 can first penetrate the packaging P (e.g., plastic film or cardboard) of an object O such that the wing 12b and nib 22b extend within the packaging P to allow the knife 10 to move in the direction A so that the edge 25 of the blade 22 can slice and open the packaging P surrounding the object O.

Depending on the desired depth of cutting, the knife 10 allows for either shallow penetration of an object O to avoid damage of contents therein if the package P (e.g., if the package is delicate or full) or a deeper penetration of the package P when desired.

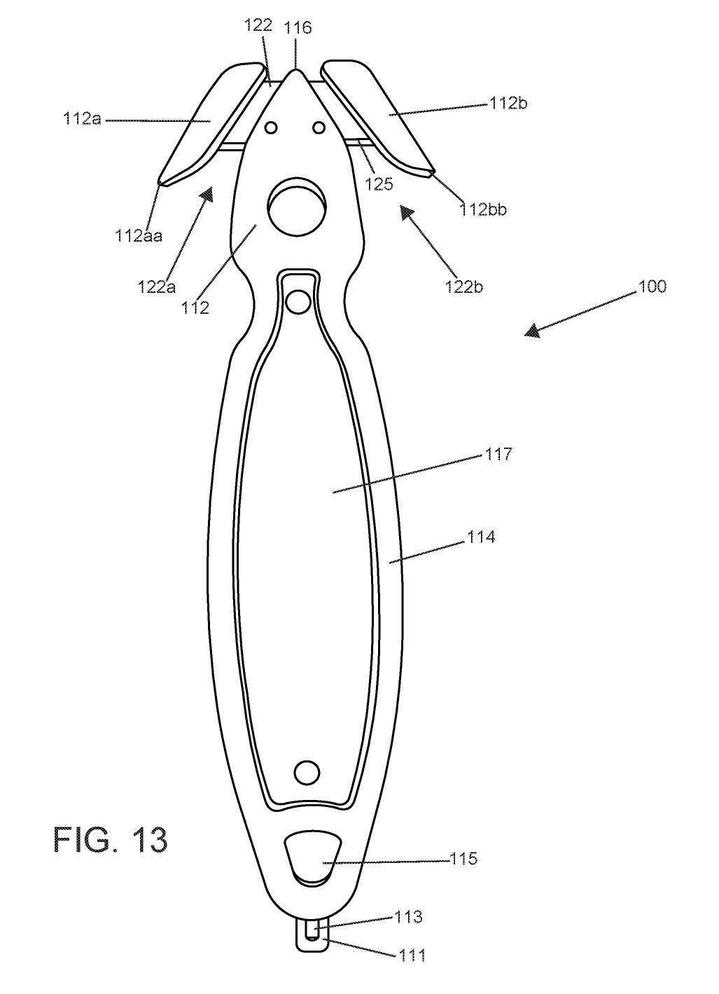

FIGS. 13-19 show a second embodiment of a knife 100 with a single nib 111 located on a handle portion 114 of the knife 100. It is noted that in FIGS. 13-18, like reference numerals are used to designate the same elements as in FIGS. 1-12. The nib 111 is generally rectangular with rounded corners to prevent injury to a user and includes a central opening 113. However, the shape of the nib 111 can be of any known or desired shape and should not be limited to a rectangular shape. The nib 111 functions in connection with the remainder of the knife 100, in the same manner as previously described.

The accompanying drawings illustrate embodiments of a safety knife and its respective constituent parts. However, the drawings are not intended to be limiting in that regard. Thus, although the description above and accompanying drawings contains much specificity, the details provided should not be construed as limiting the scope of the embodiments, but merely as providing illustrations of some of the features of the embodiments. The drawings and the description are not to be taken as restrictive on the scope of the embodiments and are understood as broad and general teachings in accordance with the present invention. While the present embodiment have been described using specific terms, such description is for illustrative purposes only, and it is to be understood that modifications and variations to such embodiments, including, but not limited to, the substitutions of equivalent features, materials, or parts, and the reversal of various features thereof, may be practiced by those of ordinary skill in the art without departing from the spirit and scope of the invention.

1. A knife for cutting an object, the knife comprising:
a handle;
a head extending from the handle;
a first wing member spaced from a first side of the head forming a first slot between the head and the first wing member;
a second wing member spaced from a second side of the head, mirror opposite the first wing member, forming a second slot between the head and the second wing member;
a blade including at least one nib extending therefrom, the blade centrally fixed within the head, the first wing member and the second wing member such that the blade spans the first slot and the second slot with the nib extending from the blade, beyond an outer periphery of one of the first wing member and the second wing member, and whereby the nib and blade are configured to puncture and cut an object.

2. The knife as set forth in claim 1, wherein the nib and the blade each extend along a same plane.

3. The knife as set forth in claim 1, wherein the blade and the nib are comprised of a single piece of material.

4. The knife as set forth in claim 3, wherein the material is a metal.

5. The knife as set forth in claim 1, wherein the blade has a tapered edge extending along one sidewall thereof.

6. The knife as set forth in claim 1, wherein an outer periphery of the nib is round at a distal end thereof.

7. The knife as set forth in claim 1, further comprising a second nib, wherein the nib extends from the blade, beyond an outer periphery of the first wing member and the second nib extends beyond the outer periphery of the second wing member.

8. A knife for cutting an object, the knife comprising:
a handle;
a head including a main body extending from a first end of the handle and delimited at an apex;
a first wing member spaced from a first side of the main body of the head and entirely independent of the main body forming a first slot between the head and the first wing member;
a second wing member spaced from a second side of the main body of the head and entirely independent of the main body, mirror opposite the first wing member forming a second slot between the head and the second wing member;
a blade including a first edge formed to cut an object and a second edge spaced from the first edge centrally fixed within the main body of the head, the first wing member and the second wing member such that the first end of the blade spans the first slot and the second slot and the apex of the head, an end of the first wing member and an end of the second wing member extend beyond the second end of the blade; and
a nib fixed to and extending from a second end of the handle.

9. The knife as set forth in claim 8, wherein the knife includes only a single nib.

10. The knife as set forth in claim 8, wherein the nib is substantially rectangular.

11. The knife as set forth in claim 8, wherein the nib has an opening formed therein.

12. The knife as set forth in claim 8, wherein the nib has a first leg extending from the handle, a second leg spaced from and extending substantially parallel to the first leg from the handle and a third leg, spaced from the handle and extending substantially perpendicular between the first leg and the second leg.

13. The knife as set forth in claim 8, wherein the nib has a first rounded corner and a second rounded corner that is spaced from the first rounded corner at a distal end of the nib.

14. The knife as set forth in claim 8, wherein the nib is comprised of a metal.
